(19) United States
(12) Patent Application Publication
(10) Pub. No.: US 2011/0194699 A1
(43) Pub. Date: Aug. 11, 2011

(54) METHOD AND SYSTEM FOR ENHANCED SOUND QUALITY FOR STEREO AUDIO

(76) Inventors: Thomas Baker, Fountain Valley, CA (US); Brima Ibrahim, Alison Viejo, CA (US); Hea Joung Kim, Irvine, CA (US)

(21) Appl. No.: 12/701,419

(22) Filed: Feb. 5, 2010

(51) Int. Cl. H04H 20/48

(52) U.S. Cl. 381/3

(57) ABSTRACT

Aspects of a method and system for enhanced sound quality for stereo audio are provided. In this regard, levels of audio signals received via an FM radio channel may be controlled based on a signal-to-noise ratio (SNR) of the RF channel. The SNR of the FM radio channel may be determined based on signal strength in an unused portion of the FM radio channel. The recovered audio signals may comprise an FM multiplex signal, and an unused portion of the FM radio channel may be a guard band adjacent to a carrier of the FM multiplex signal. A level of one or both of a mono component and a stereo component of an FM multiplex signal may be controlled based on the SNR.

### CROSS-REFERENCE TO RELATED APPLICATIONS/INCORPORATION BY REFERENCE

Not Applicable

### FIELD OF THE INVENTION

Certain embodiments of the invention relate to wireless communications. More specifically, certain embodiments of the invention relate to a method and system for enhanced sound quality for stereo audio.

### BACKGROUND OF THE INVENTION

With the increasing popularity of various wireless standards and technologies, there is a growing demand to provide a simple and complete solution for wireless communications applications. In this regard, electronics manufacturers are increasingly attempting to incorporate multiple wireless technologies into portable electronic devices. For example, wireless technologies that are seeing widespread deployment include FM radio, Bluetooth (BT), GPS, Wi-Fi, and RFID.

Although desirable to users, incorporating multiple wireless communication technologies into devices such as wireless handsets may pose problems in terms of cost and complexity. In this regard, combining a plurality of wireless technologies into a portable electronic device may require separate processing hardware and/or separate processing software. Moreover, coordinating the reception and/or transmission of data to and/or from the portable electronic device may require significant processing overhead that may impose certain operation restrictions and/or design challenges.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for enhanced sound quality for stereo audio, substantially as illustrated by and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating a FM multiplex signal (FM MPX), in accordance with an embodiment of the invention.

FIG. 2 is a diagram illustrating an exemplary FM frequency band, in accordance with an embodiment of the invention.

FIG. 3 is a block diagram of an exemplary communication device that is operable to provide enhanced sound quality for stereo audio, in accordance with an embodiment of the invention.

FIG. 4A is a diagram illustrating exemplary audio signals, in accordance with an embodiment of the invention.

FIG. 4B is a diagram illustrating control of audio levels based on signal-to-noise ratio of a received signal, in accordance with an embodiment of the invention.

FIG. 5 is a diagram illustrating control, based on signal to noise ratio, of a transition between mono and stereo modes in a communication device, in accordance with an embodiment of the invention.

FIG. 6 is a flow chart illustrating exemplary steps for controlling audio levels based on SNR, in accordance with an embodiment of the invention.

### DETAILED DESCRIPTION OF THE INVENTION

Certain embodiments of the invention may be found in a method and system for enhanced sound quality for stereo audio. In various embodiments of the invention, levels of audio signals received via a RF channel may be controlled based on a signal-to-noise ratio (SNR) of the RF channel. The SNR of the RF channel may be determined based on signal strength in an unused portion of the RF channel. The recovered audio signals may comprise an FM multiplex signal, and an unused portion of the FM radio channel may be a guard band adjacent to a carrier of the FM multiplex signal. A level of one or both of a mono component and a stereo component of an FM multiplex signal may be controlled based on the SNR.

A stereo component of an FM multiplex signal may be scaled prior to combining the stereo component and a mono component to generate left and right audio signals. The stereo component may be scaled by a blending factor. The blending factor may, for example, be equal to a first constant when the SNR is less than a first threshold, grow exponentially when the SNR is between the first threshold and a second threshold, and may be equal to a second constant when the SNR is greater than the second threshold. The first threshold and the second threshold may be programmable. The recovered audio signals may be left and right audio signals. The recovered audio signals may be scaled by a muting factor. The muting factor may, for example, be equal to 1 when the SNR is above a threshold, and may decrease based on one or more slope values when the SNR is between 0 and the threshold. The threshold and/or the one or more slope values may be programmable.

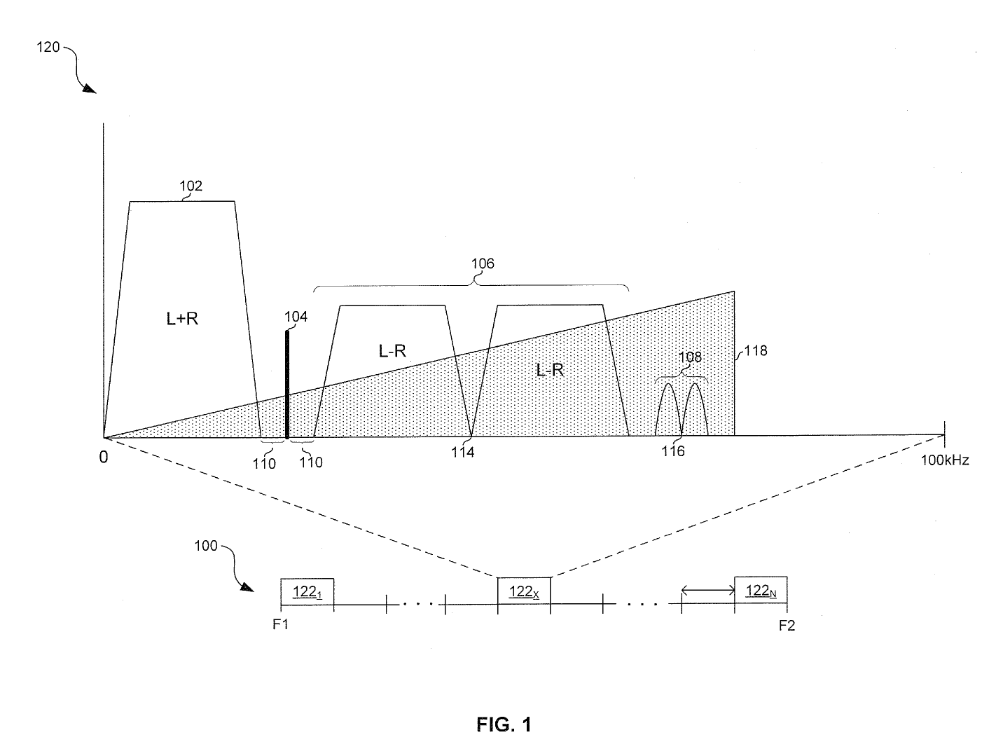

FIG. 1 is a diagram illustrating an FM radio band and an FM multiplex signal (FM MPX), in accordance with an embodiment of the invention. Referring to FIG. 1 there is shown an FM radio band 100 that spans from F1 to F2 and comprises FM radio channels 122₁-122_{N}. Also shown is an FM multiplex signal (FM MPX) 120 that is representative of the signals that may be present on a particular FM radio channel 122. In an exemplary embodiment of the invention, F1 may be 87 MHz and F2 may be 108 MHz.

The FM MPX 120 comprises a mono component 102, a carrier 104, a stereo component 106, and a radio data services (RDS) component 108. The mono component 102 may comprise a sum of left and right baseband audio information.

The carrier 104 may comprise, for example, a 19 kHz sine wave. There may be unused frequencies on either side of the carrier signal 104 to prevent distortion or interference with the carrier signal. The unused frequencies may be referred to as guard bands 110.

The stereo component 106 may be generated by subtracting a right baseband audio signal from a left baseband audio signal to generate a difference signal. The difference signal may then be modulated onto a double-sideband suppressed carrier (DSBSC) signal which may, for example, be centered at 38 kHz and occupy the baseband range from 23 to 53 kHz.

The RDS component 108 may comprise Manchester encoded data modulated onto a 57 kHz carrier. The RDS component 108 may be utilized to carry data such as text. In this regard, the RDS component 108 is frequently used to identify the call letters of the radio station transmitting on the channel and/or to identify the audio currently being transmitted on the channel.

Also shown in FIG. 1 is a representation 118 of the noise present on the FM radio channel 122_{X}. In this regard, FIG. 1 illustrates that noise increases at higher frequencies of the FM radio channel 122_{X}. Consequently, the mono component 102 of a FM radio channel 122_{X} has a higher signal-to-noise (SNR) ratio than the stereo component 106 of the same channel 122_{X}. In this regard, the SNR of the mono component 102 is typically ˜19 dB higher than the SNR of the stereo component 106.

Although various aspects of the present invention are described with respect to the FM MPX 120, the invention is not so limited. Accordingly, various aspects of the invention may apply to reception of any frequency modulated audio information.

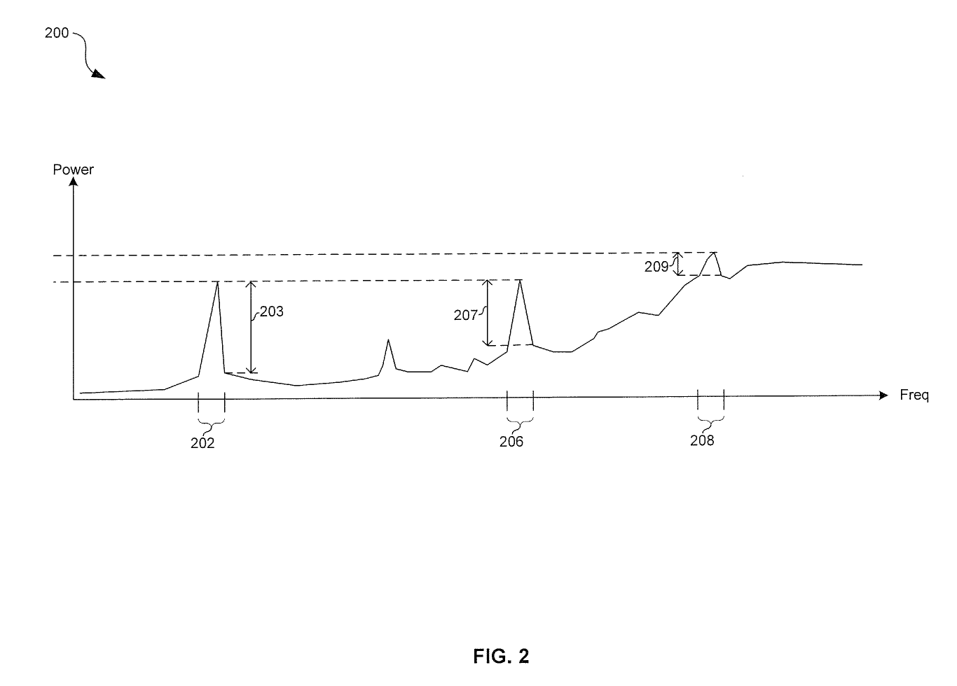

FIG. 2 is a diagram illustrating signal-to-noise ratio of an exemplary frequency band, in accordance with an embodiment of the invention. Referring to FIG. 2 there is shown a power spectral density (PSD) for an exemplary frequency band 200 comprising FM radio channels 202, 206, and 208. FIG. 2 illustrates that signal strength measurement alone may be insufficient for determining signal quality because of the change in the noise floor over the frequency band 200. In this regard, while channel 208 actually has higher signal strength than channel 202, its SNR 209 is significantly lower than the SNR 203 of the channel 202. Similarly, although channels 302 and 306 have the same RSSI, the SNR 203 is higher than the SNR 207. Accordingly, if signal strength was utilized to control audio signal levels, the perceived audio quality may be good for the channel 202, moderate for the channel 206, and poor for the channel 208.

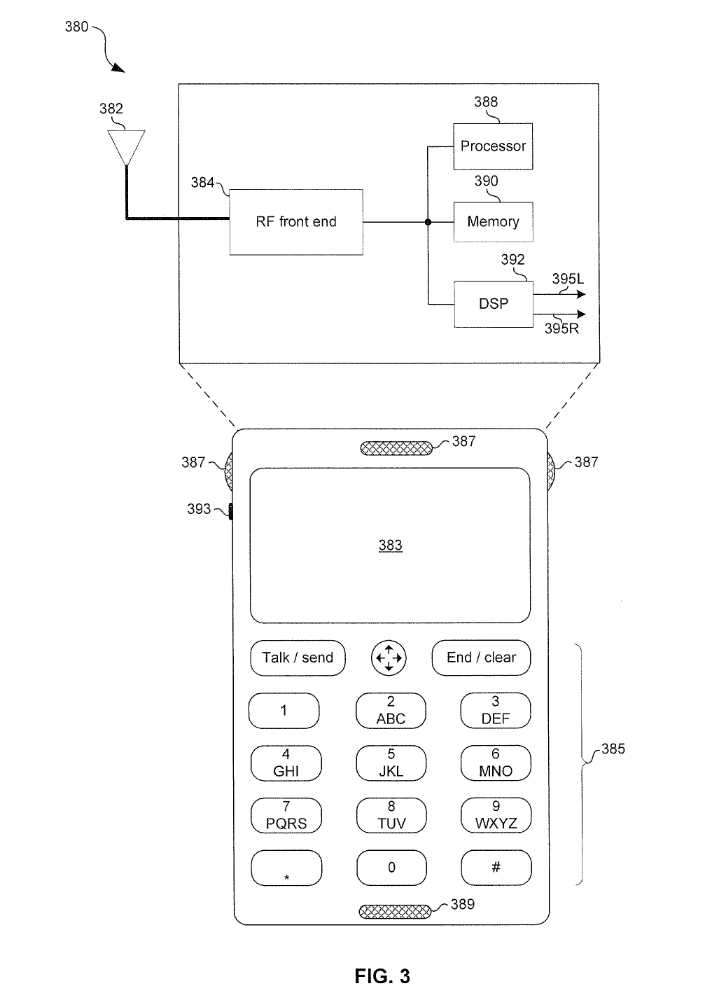

FIG. 3 is a block diagram of an exemplary communication device that is operable to provide enhanced sound quality for stereo audio, in accordance with an embodiment of the invention. Referring to FIG. 3, the communication device 380 may comprise an antenna 382, a RF front-end 384, a processor 388, a memory 390, a DSP 392, a display 383, user controls 385, a speaker 387, and a microphone 389. In this regard, the communication device 380 may be referred to as a “receiver” with the understanding that the communication device 380 is operable to receive signals but is not limited to receiver functions. In other words, the communication device 380 referred to herein as a receiver may also be operable to transmit signals such as FM, WLAN, PAN, and/or Cellular signals.

The antenna 382 may be suitable for transmitting and/or receiving electromagnetic signals. Although a single antenna is illustrated, the invention is not so limited. In this regard, the RF front-end 384 may utilize a common antenna for transmission and reception of signals adhering to one or more wireless standards, may utilize different antennas for each supported wireless standard, and/or may utilize a plurality of antennas for each supported wireless standard.

The RF front-end 384 may comprise suitable logic circuitry and/or code that may be operable to perform amplification, down-conversion, filtering, demodulation, and/or analog-to-digital conversion of received signals. For example, the RF front-end may be operable to tune to the channel 122_{X}, process the signal received on the channel 120_{X} to recover the baseband FM MPX 120, convert the FM MPX 120 to a digital representation, and output the digital baseband signal to the DSP 392. In some embodiments of the invention, the RF front-end may also be operable to process the FM MPX 120 to recover mono audio signals, stereo audio signals, and/or RDS signals, convert the mono, stereo, and/or RDS signals to a digital representation, and output the digital audio and/or RDS signals to the DSP 392. Additionally, the RF front-end 384 may comprise suitable logic, circuitry, interfaces, and/or code that may be operable to perform amplification, up-conversion, filtering, modulation, and/or digital-to-analog conversion of to-be-transmitted signals. For example, the RF front-end 384 may be operable to receive digital baseband signals from the DSP 392, generate corresponding RF signals, and transmit the RF signals via the antenna(s) 382.

In addition to FM MPX signals, the RF front-end 384 may be operable to transmit and/or receive signals in accordance with, for example, cellular, WiMAX, Wi-Fi, Bluetooth, Zigbee, T1/E1, Ethernet, USB, IEEE 1394, analog audio standards, analog video standards, digital audio standards, and/or digital video standards. In various embodiments of the invention, the RF front-end 384 may be tuned and/or otherwise controlled via one or more signals from, for example, the processor 390 and/or the DSP 392. In this regard, in various embodiments of the invention, a gain of the RF front-end 384 may be controlled by one or more signals from the processor 390 and/or the DSP 392. In an exemplary embodiment of the invention, the RF front-end 384 may comprise a received signal strength indicator (RSSI) that may be utilized to determine received signal strength over at least a portion of the bandwidth of the received signal.

The DSP 392 may comprise suitable logic, circuitry, and/or code that may be operable to perform computationally intensive processing of digital signals. In various embodiments of the invention, the DSP 392 may encode, decode, transcode, modulate, demodulate, encrypt, decrypt, scramble, descramble, filter, equalize, compress, decompress, convert, format, packetize, rate convert, and/or otherwise process digital signals. In this manner, the DSP 392 may be operable to recover mono audio signals, stereo audio signals, and/or RDS signals from the FM MPX 120, and may be operable to process the recovered signals to, for example, improve the sound quality of the audio. In this regard, the DSP 392 may be operable to process the FM MPX 120 to generate left and right output audio signals 395_{L} and 395_{R}. In addition to FM MPX signals, the DSP 392 may be operable to process and/or generate signals in accordance with, for example, cellular, WiMAX, Wi-Fi, Bluetooth, Zigbee, T1/E1, Ethernet, USB, IEEE 1394, analog audio standards, analog video standards, digital audio standards, and/or digital video standards.

The processor 388 may comprise suitable logic, circuitry, and/or code that may enable processing data and/or controlling operations of the communication device 380. In this regard, the processor 388 may be enabled to provide control signals to the various other components of the communication device 380. The processor 388 may also control transfers of data between various portions of the communication device 380. Additionally, the processor 388 may enable execution of applications, programs, and/or code for processing data and/or effectuating operation of the communication device 380. Exemplary control signals generated by the processor 388 may comprise one or more signals to tune the RF front-end 384, and to control audio signal levels in the communication device 380.

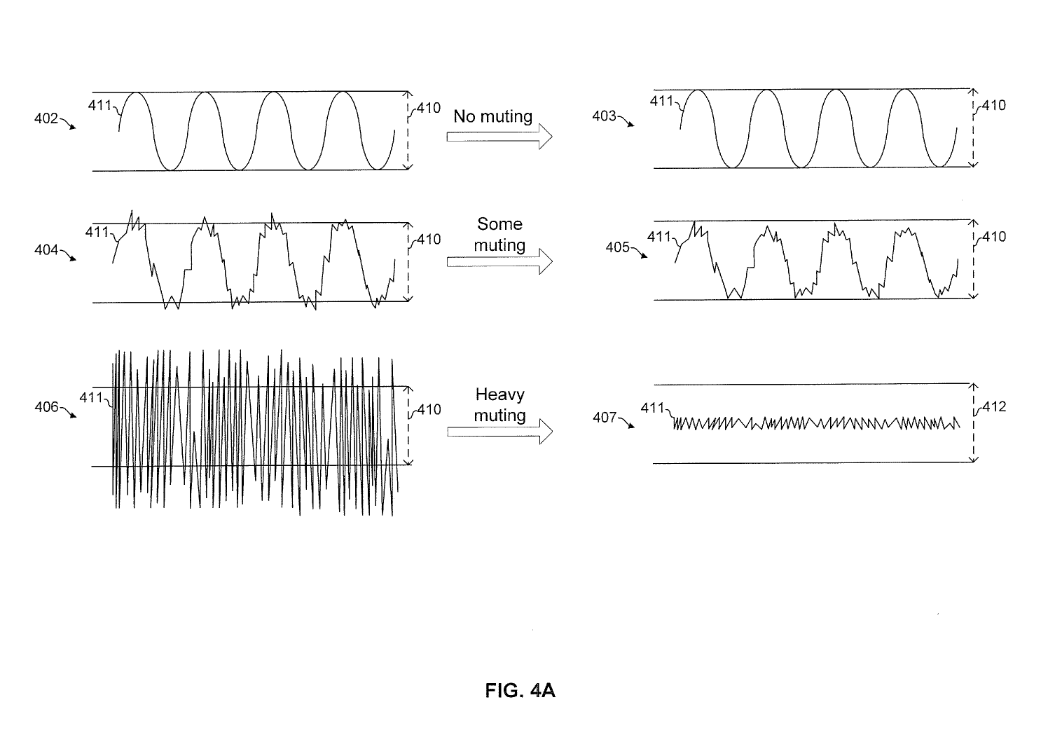

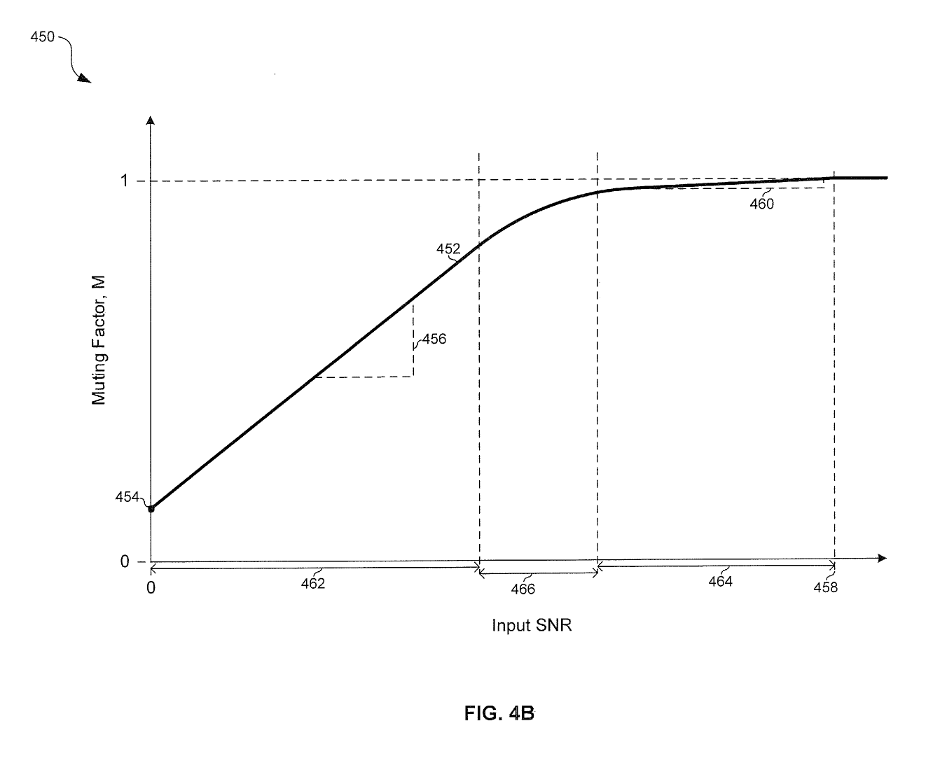

The memory 390 may comprise suitable logic, circuitry, interfaces, and/or code that may be operable to store information such as parameters and/or code that may effectuate the operation of the communication device 380. Stored information may comprise received data and/or data to be presented, transmitted, and/or otherwise processed. The parameters may comprise configuration data and the code may comprise operational code such as software and/or firmware, but the information need not be limited in this regard. In an exemplary embodiment of the invention, the memory 390 may store instructions and/or parameters that may be utilized to control audio levels in the communication device 380. For example, the memory 390 may store tables, instructions, and/or parameters for determining values of the muting factor, M, and/or the blending factor, B, described below with respect to FIGS. 4A-6.

The display 383 may be operable to provide visual information to, and/or enable interaction by, a user of the communication device 380. In various embodiments of the invention, a graphical user interface may be presented via the display 383. In various embodiments of the invention, a visual media content such as video, images, and text may be presented via the display 383.

The user controls 385 may be operable to enable user interaction with the communication device 380 to control services and/or content handled by the communication device 380. The user controls 385 may comprise, for example, a keypad, a keyboard, a roller ball, a multidirectional button, a scroll wheels, and/or a touch screen. In various embodiments of the invention, the user controls 385 may enable a user to control a desired volume of audio signals, such as 395_{L} and 395_{R}, output by the communication device 380.

The speakers 387 may be operable to present audio information to a user. The speakers 387 may present voice from a phone call and/or music or ringtones received and/or played back by the communication device 380. In this regard, aspects of the invention may enable controlling, based on SNR of received signals, the level of audio signals 395_{L} and 395_{R} driven to the speakers 387.

The headphone jack 393 may be operable to present audio information to a user via headphones and/or a headset plugged into the jack 393. The headphone jack 393 may present voice from a phone call and/or music or ringtones received and/or played back by the communication device 380. In this regard, aspects of the invention may enable controlling, based on SNR of received signals, the level of audio signals 395_{L} and 395_{R} driven to the headphone jack 393.

The microphone 389 may be operable to convert acoustic signals into electronic signals. The microphone may enable a user to participate in a phone call and/or interact with the cellular enabled communication device via oral input.

In operation, the RF front-end 384 may be tuned to a selected FM channel 122_{X} which may lie, for example, in the FM broadcast band of 87 MHz to 108 MHz. The RF front-end 384 may amplify, down-convert, filter, and demodulate the FM MPX 120 received on the selected channel 122_{X} to generate a corresponding digital baseband signal which may comprise the mono component 102, the stereo component 106, and/or the RDS component 108.

In an exemplary embodiment of the invention, the RF front-end 384 may make two signal strength measurements of the received FM MPX 120. The first measurement may be made in the guard band 110. This portion of the FM MPX 120 may ideally contain no signal and thus the first measurement may correspond to noise on the selected channel 122_{X}. The second measurement may be centered at, for example, the frequency of the carrier 104, a frequency within the mono component 102, and/or a frequency within the stereo component 106. The second measurement may thus correspond to strength of a desired signal on the selected channel 122_{X}. The second measurement may be divided by the first measurement to determine a SNR of the selected channel 122_{X}.

In another embodiment of the invention, the RF front-end measure the signal strength in the guard band 110 to determine the noise on the selected channel 122_{X}, and then may estimate the strength of the desired signal on the selected channel 122_{X} based on, for example, standard signal deviations used by the station transmitting the signals.

In another embodiment of the invention, the measurements may be made on the digital baseband signal by the DSP 392 and the DSP 392 may determine the SNR. In this regard, the DSP 392 may be operable to determine signal strength and/or may be operable to utilize other techniques such as a fast Fourier transform (FFT) for determining the SNR.

After the SNR is determined, signal levels may be adjusted based on the SNR. In various embodiments of the invention, the levels of the received RF signal may be adjusted in the RF front-end 384 and/or the levels of the recovered baseband signal may be adjusted in the RF front-end 384 and/or the DSP 392. For example, a level of the mono component 102 and/or a level of the stereo component 106 of the FM MPX 120 may be adjusted by the DSP 392 prior to combining the mono component 102 and the stereo component 106 to generate output audio signals 395_{L} and 395_{R}. Alternatively or additionally, the level of the output audio signals 395_{L} and 395_{R} may be adjusted by the DSP 392 or the processor 388.

FIG. 4A is a diagram illustrating controlling audio signal levels based on SNR, in accordance with an embodiment of the invention. Referring to FIG. 4A there is shown graphs 402-407 depicting an audio signal 411 which may correspond to, for example, either of the output audio signals 395_{L} and 395_{R} described with regard to FIG. 3. The levels 410 depicted in the graphs 402-407 may correspond to a desired volume set by a listener. In this regard, the volume 410 may describe actual volume and/or may describe perceived volume, where “actual” volume as used herein may describe a measured volume, and “perceived” volume as used herein may describe the volume as a human listener perceives it.

The graphs 402 and 403 illustrate an instance where the signal 411 has been recovered from a FM channel having a high SNR, such as the channel 202 described with respect to FIG. 2. Accordingly, the signal may have volume 410 and no signal level adjustment of the signal may be necessary to prevent an undesirable listener experience.

The graphs 404 and 405 illustrate an instance where the signal 411 has been recovered from a received FM channel having a moderate SNR, such as the channel 206 described with respect to FIG. 2. Accordingly, the signal 411 in graph 404 has some noise on it, and the noise may cause the peak volume to exceed the volume 410. Accordingly, aspects of the invention may enable detecting the SNR, and adjusting levels of the signal 411 based on the SNR. In this manner, as shown in graph 405, the audio signal levels may be adjusted such that the signal 411 is maintained at the desired volume 410.

The graphs 406 and 407 illustrate an instance where the signal 411 has been received on a FM channel having a low SNR, such as the channel 208 described with respect to FIG. 2. Accordingly, the signal 411 in graph 406 is essentially all noise and the noise may cause the peak volume to be greater than 410. Accordingly, aspects of the invention may enable detecting the SNR, and adjusting levels of the signal 411 based on the SNR. In this regard, because the signal 411 is essentially all noise in the graph 406, the signal 411 may be attenuated such that its volume is much lower than the volume 410 as shown in graph 407. In this regard, it may be a user preference whether, for example, the signal is attenuated such that it is inaudible or is attenuated such that it is barely audible. A user may desire the signal to be barely audible so that, for example, the user knows that the receiver is turned on.

FIG. 4B is a diagram illustrating control of audio levels based on signal-to-noise ratio of a received signal, in accordance with an embodiment of the invention. Referring to FIG. 4B, there is a graph 450 having an x-axis that corresponds to SNR of a received signal and a y-axis that corresponds to power of an audio signal recovered from the received signal. In the graph 450, power of the audio signal is normalized to maximum volume; maximum volume may be set by a user.

As described with respect to FIG. 4A, noise in an audio signal, such as the signals 395_{L} and 395_{R} (FIG. 3) recovered from a received signal, such as the FM MPX 120, may increase as the SNR of the received signal decreases. Furthermore, as the noise in the audio signals 395_{L} and 395_{R} increases, the actual or perceived volume of the audio signal, or at least the noisy parts of the audio signal, may increase. Accordingly, the signals 395_{L} and 395_{R} may be scaled by a muting factor, M, to maintain a desired volume, as described in the following equations:

395_{R}=M*((R+L)−(L−R)) EQ. 3

395_{L}=M*((R+L)+(L−R)) EQ. 4

where (R+L) is the mono component 102, (L−R) is the stereo component 106, and M is the muting factor.

In an exemplary embodiment of the invention, M may be described by the characteristic 452. In this regard, the characteristic 452 may be described by a stop point 454, a first slope 456, a second slope 460, and a threshold 458.

The stop point 454 may correspond to a minimum value of the muting factor, M, that is to be applied to the signals 395_{L} and 395_{R}. In this regard, scaling the signal by the start point 454 may, for example, result in the signals 395_{L} and 395_{R} being imperceptible or barely perceptible to a listener.

The threshold 458 may correspond to an SNR below which M has a value of less than 1. That is, below the threshold 458, the audio signal 411 may be reduced below the maximum volume, which may be set by a listener.

The first slope 456 may determine the rate a which M changes over a range 462 of SNR values and the second slop 462 may determine a rate at which M changes over a range 464 of SNR values. In the range 466, may change at a rate somewhere between the rates corresponding to ranges 462 and 464. In this regard, the value of the threshold 458, the slope 456, the slope 460, and/or user preferences may determine how rounded the characteristic 452 is in the region 466

The characteristic 452 is just an exemplary characteristic for M, and the behavior of M may be defined or described by any suitable function(s). In this regard, a characteristic describing M is not limited to being described by a start point a stop point and one or more slopes but may be any suitable function such as, for example, an exponential or quadratic function. Also, N may be determined via, for example, mathematical and/or logical operations performed by the processor 388 or the DSP 392, and/or may be determined via, for example, a look-up table stored in the memory 390. In various embodiments of the invention, the start point 454, the threshold 458, the slope 456, and the slope 460 may be programmable and the slope and/or function defining the behavior of M in the regions 462, 464, and 466 may be programmable.

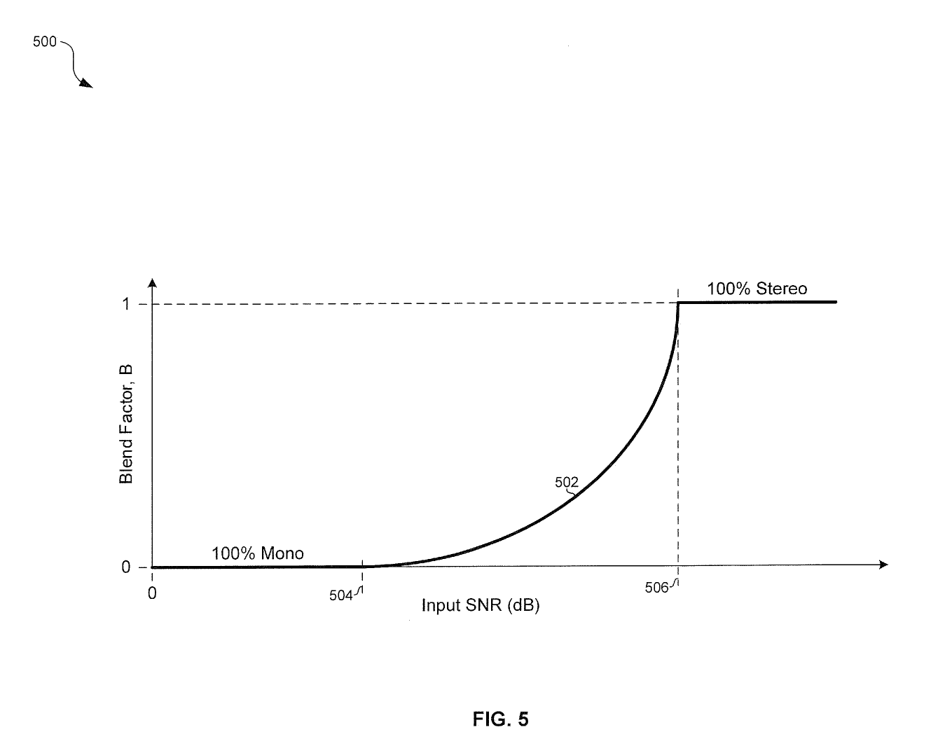

FIG. 5 is a diagram illustrating control, based on signal-to-noise ratio, of a transition between mono and stereo modes in a communication device, in accordance with an embodiment of the invention. Referring to FIG. 5 there is shown an exemplary behavior 502 of a blending factor B, where B determines the extent to which the stereo component 106 is combined with the mono component 102, as described below with respect to EQs 1 and 2.

As described with respect to FIG. 1, noise is typically higher in the stereo component 106 than in the mono component 102. Consequently, although combining the stereo component 106 with the mono component 102 may produce the desirable result of left and right stereo signals, combining the stereo component 106 with the mono component 102 may also significantly increase the noise present in the output audio signals 395_{L} and 395_{R}. Accordingly, as the SNR of the received FM MPX 120 decreases, the benefits of combining the stereo component 106 with the mono component 102 (the aurally pleasing quality of stereo audio) eventually become outweighed by the aurally displeasing effects of the noise introduced by the stereo component 106. However, there is no definite transition point where mono mode is better than stereo mode. Accordingly, aspects of the invention may enable gradually transitioning between stereo and mono modes. In this regard, the output audio signals 395_{L} and 395_{R} may be generated utilizing the following equations:

395_{R}=(R+L)−B*(L−R) EQ. 3

395_{L}=(R+L)+B*(L−R) EQ. 4

where (R+L) is the mono component 102, (L−R) is the stereo component 106, and B is the blending factor.

In the exemplary embodiment of the invention depicted in FIG. 5B, B may be set to 0 for a SNR less than threshold 504, B may be exponentially increased between thresholds 504 and 506, and B may be set to 1 for a SNR greater than threshold 506. However, since FIG. 5B is just an exemplary characteristic for B, the behavior of B may be defined or described by any other suitable function(s). In this regard, a characteristic describing B is not limited to three segments, nor is each segment limited to being linear or exponential. In this regard, B may be described by any suitable function such as, for example, a linear, quadratic, or exponential function. Also, B may be determined, for example, via mathematical and/or logical operations performed by the processor 388 or the DSP 392, and/or via a look-up table stored in the memory 390. Additionally, the thresholds 504 and 506 may be programmable and the slope and/or function defining the behavior of B between the thresholds 504 and 506 may be programmable.

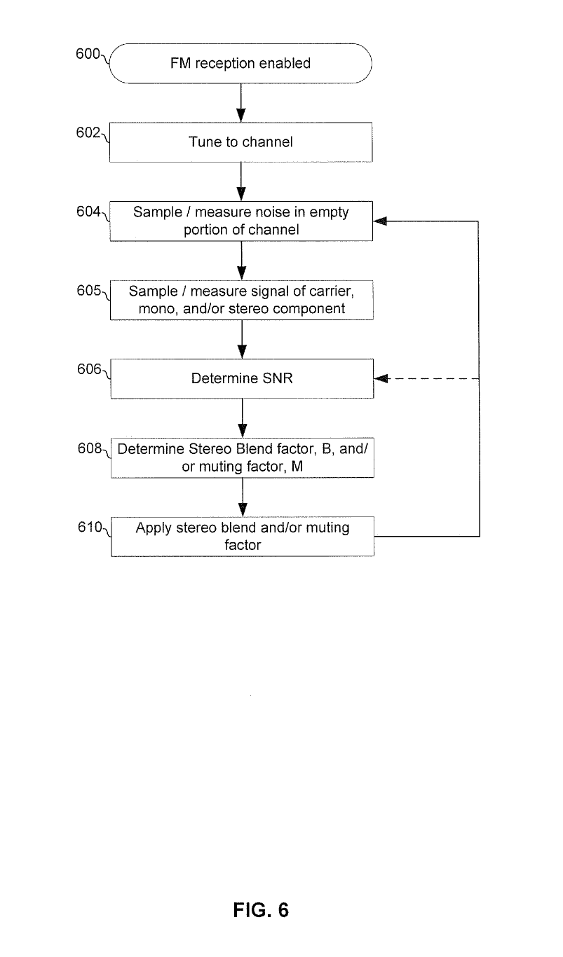

FIG. 6 is a flow chart illustrating exemplary steps for controlling stereo blending, in accordance with an embodiment of the invention. Referring to FIG. 6, the exemplary steps may begin with step 600 in which FM reception may be enabled in the communication device 180. For example, a user of the communication device 180 may turn on an FM receive function of the communication device 180. In step 602, the user of the communication device 180 may select the FM channel 122_{X} for listening to. Accordingly, the RF front-end 384 and/or the DSP 392 may be configured for reception of the selected channel 122_{X}. In step 604, signal strength in the band 110 of the FM MPX 120 may be measured and may be stored as a noise measurement. In step 605, the signal strength of the carrier 104, the mono component 102, and/or the stereo component 106 may be measured and stored as a signal strength measurement. In step 606, the signal strength measurement of step 605 may be divided by the noise measurement of step 604 to determine the SNR of the channel 122_{X}.

In step 608, a value for the blending factor, B, and/or a value for the muting factor, M, may be determined based on the SNR determined in step 606. In various embodiments of the invention, the value of B may be calculated based on one or more parameters such as the thresholds 504 and 506, based on one or more logic and/or mathematical functions that describe the behavior of B, and/or based on values in a look-up table. In various embodiments of the invention, the value of M may be calculated based on one or more parameters such as the stop point 458, the slope 460, the slope 456, and/or the stop point 454; based on one or more logical and/or mathematical functions that describe the behavior of M; and/or based on values in a look-up table. In this regard, in an exemplary embodiment of the invention, the muting factor M and the blending factor B may both be utilized to adjust audio signal levels and the signals 395_{L} and 395_{R} may be described by the following equations:

395_{R}=M*((R+L)−B*(L−R)) EQ. 5

395_{L}=M*((R+L)+B*(L−R)) EQ. 6

In step 610, the value of M and/or B calculated in step 608 may be applied to signals such as the output audio signals 395_{L} and 395_{R}. In various embodiments of the invention, M and/or B may be applied via a digital multiplier, an analog multiplier, and/or by controlling the gain of an amplifier, buffer, or other analog and/or digital circuit element. Subsequent to step 610, the exemplary steps may return to step 604 or 606.

Various aspects of a method and system for enhanced sound quality for stereo audio are provided. In an exemplary embodiment of the invention, levels of audio signals received via a FM radio channel 122_{X} may be controlled based on a signal-to-noise ratio (SNR) of the FM radio channel 122_{X}. The SNR of the FM radio channel 122_{X} may be determined based on signal strength in an unused portion of the FM radio channel 122_{X}. The recovered audio signals may comprise an FM MPX 120, and an unused portion of the FM radio channel 122_{X} may be a guard band 110 adjacent to a carrier 104 of the FM MPX 120. A level of one or both of a mono component 102 and a stereo component 106 of the FM MPX 120 may be controlled based on the SNR.

A stereo component 106 of the FM MPX 120 may be scaled prior to combining the stereo component 106 and a mono component 102 of the FM MPX 120 to generate left and right audio signals 395_{L} and 395_{R}. The stereo component 106 may be scaled by a blending factor B. The blending factor, B, may, for example, be equal to 0 when the SNR is less than a first threshold 504, grow exponentially when the SNR is between the first threshold 504 and a second threshold 506, and may be equal to 1 when the SNR is greater than the second threshold 506. The first threshold 504 and the second threshold 506 may be programmable. The recovered audio signals may be left and right audio signals 395_{L} and 395_{R}. The recovered audio signals may be scaled by a muting factor, M. The muting factor, M, may, for example, be equal to 1 when the SNR is above a threshold, and may decrease based on slope values 456 and 460 when the SNR is between 0 and the threshold 458 The threshold 458 and/or the slope values 456 and 460 may be programmable.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for enhanced sound quality for stereo audio.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for signal processing, the method comprising:
performing by one or more circuits and/or processors in a communication device:
determining a signal-to-noise ratio of a FM radio channel based on signal strength in an unused portion of said FM radio channel;
recovering audio signals from FM radio signals received on said FM radio channel; and
controlling levels of said recovered audio signals based on said determined signal-to-noise ratio.

2. The method according to claim 1, wherein said recovered audio signals comprise an FM multiplex signal.

3. The method according to claim 2, wherein said unused portion of said FM radio channel is a guard band adjacent to a carrier of said FM multiplex signal.

4. The method according to claim 2, comprising controlling a level of one or both of a mono component and a stereo component of said FM multiplex signal.

5. The method according to claim 4, comprising scaling said stereo component of said FM multiplex signal prior to combining said stereo component and said mono component to generate left and right audio signals.

6. The method according to claim 5, comprising scaling said stereo component utilizing a blending factor, where said blending factor:
is equal to a first constant when said signal-to-noise ratio is less than a first threshold;
grows exponentially when said signal-to-noise ratio is between said first threshold and a second threshold; and
is equal to a second constant when said signal-to-noise ratio is greater than said second threshold.

7. The method according to claim 6, wherein said first threshold and said second threshold are programmable.

8. The method according to claim 1, wherein said recovered audio signals comprise left and right audio signals.

9. The method according to claim 1, comprising scaling said recovered audio signals by a muting factor, where:
said muting factor is equal to 1 when said signal-to-noise ratio is above a threshold; and
said muting factor decreases based on one or more slope values when said signal-to-noise ratio is between 0 and said threshold.

10. The method according to claim 9, wherein said threshold and said one or more slope values are programmable.

11. A system for signal processing, the system comprising:
one or more circuits and/or processors for use in a communication device, said one or more circuits and/or processors being operable to:
determine a signal-to-noise ratio of a FM radio channel based on signal strength in an unused portion of said FM radio channel;
recover audio signals from FM radio signals received on said FM radio channel; and
control levels of said recovered audio signals based on said determined signal-to-noise ratio.

12. The system according to claim 1, wherein said recovered audio signals comprise an FM multiplex signal.

13. The system according to claim 2, wherein said unused portion of said FM radio channel is a guard band adjacent to a carrier of said FM multiplex signal.

14. The system according to claim 2, wherein said one or more circuits and/or processors are operable to control a level of one or both of a mono component and a stereo component of said FM multiplex signal.

15. The system according to claim 4, wherein said one or more circuits and/or processors are operable to scale said stereo component of said FM multiplex signal prior to combining said stereo component and said mono component to generate left and right audio signals.

16. The system according to claim 5, wherein said one or more circuits and/or processors are operable to scale said stereo component utilizing a blending factor, where said blending factor:
is equal to a first constant when said signal-to-noise ratio is less than a first threshold;
grows exponentially when said signal-to-noise ratio is between said first threshold and a second threshold; and
is equal to a second constant when said signal-to-noise ratio is greater than said second threshold.

17. The system according to claim 6, wherein said first threshold and said second threshold are programmable.

18. The system according to claim 1, wherein said recovered audio signals comprise left and right audio signals.

19. The system according to claim 1, wherein said one or more circuits and/or processors are operable to scale said recovered audio signals by a muting factor, where:
said muting factor is equal to 1 when said signal-to-noise ratio is above a threshold; and
said muting factor decreases based on one or more slope values when said signal-to-noise ratio is between 0 and said threshold.

20. The system according to claim 9, wherein said threshold and said one or more slope values are programmable.
